(19) United States
(12) Patent Application Publication
(10) Pub. No.: US 2026/0330013 A1
(43) Pub. Date: Oct. 22, 2026

(54) OPERATING SYSTEM (OS)-LEVEL ARTIFICIAL INTELLIGENCE (AI) AGENT FIREWALL

(71) Applicant: Dorian Cartwright, San Jose, CA (US)

(72) Inventor: Dorian Cartwright, San Jose, CA (US)

(21) Appl. No.: 19/547,396

(22) Filed: Feb. 23, 2026

Related U.S. Application Data
(60) Provisional application No. 63/957,025, filed on Jan. 9, 2026.

(51) Int. Cl. G06F 21/55

(52) U.S. Cl. CPC G06F 21/554; G06F 2221/033

(57) ABSTRACT

An operating system (OS)-level artificial intelligence (AI) agent firewall mediates interactions between integrated AI agents and application-layer resources. To overcome the limitations of isolated event tracking, the AI agent firewall intercepts AI agent requests and dynamically generates a Directed Acyclic Graph (DAG) to map the causal chain of multi-step workflows. Nodes within the DAG represent system entities, including the originating AI agent and dynamically generated secondary executable artifacts, while edges represent discrete operating system calls. By evaluating these full causal chains against established security policies, the system performs multi-step malicious pattern detection. This enables the AI agent firewall to identify and block instances where an AI agent utilizes a secondary artifact to indirectly execute malicious proxy behavior or access encrypted data.

### CROSS-REFERENCE TO RELATED APPLICATION

The present application claims priority under 35 USC 119(e) to U.S. Provisional App. No. 63/957,025, filed Jan. 9, 2026 by Dorian Cartwright and entitled OPERATING-SYSTEM-LEVEL ARTIFICIAL-INTELLIGENCE AGENT FIREWALL FOR CONTROLLED APPLICATION-LAYER ACCESS, the contents of which are hereby incorporated in its entirety.

### FIELD OF THE INVENTION

The present disclosure relates to cybersecurity, and more particularly, to preventing malicious activity by autonomous AI agents operating at the operating system level through real-time causal chain analysis of multi-step agent workflow.

### BACKGROUND

AI agents, such as Windows 11 Copilot, OpenClaw and Samsung Android Galaxy 26, are increasingly integrated into operating systems to provide assistance, automation, analytics, and learning based on user activity and system state. Such agents may operate continuously and may observe user interactions, application behavior, and system events in real time. To obtain sufficient context for operation, many AI agents access application-layer data, including rendered user interface content, accessibility information, inter-process communications, and other signals that may exist in plaintext at or above the presentation layer.

While this access enables advanced functionality, it introduces substantial security and privacy risks. First, applications that rely on end-to-end encryption, such as secure messaging or confidential communication applications, are designed to prevent third-party access to message contents. However, operating-system-level AI agents that capture screen content, accessibility streams, or rendered application output may observe plaintext information after decryption, thereby undermining the security guarantees of such applications. Second, AI agents are subject to malicious prompt injection and adversarial manipulation. Malicious processes, compromised applications, or external attackers may introduce crafted prompts, interface elements, or signals intended to influence an AI agent's behavior, cause unauthorized actions, or extract sensitive data.

Traditional permission systems grant static access rights but do not inspect, filter, or regulate the content, intent, or behavioral patterns of AI agent interactions. Existing security solutions are fundamentally ill-equipped to address threats posed by OS-level autonomous agents. Cloud-based security operations center platforms operate downstream of agent activity, relying on logs generated after the fact, providing no real-time operating-system-level visibility. Traditional layer 7 firewalls inspect network traffic only and cannot detect operating-system-level agents accessing decrypted application data rendered in memory. Agent guardrail frameworks operate at inference time within AI model pipelines, meaning there is no operating-system-level monitoring, no workflow composition analysis, and no secondary process attribution. Most critically, while endpoint detection and response tools evaluate discrete, individual events in isolation, they fundamentally fail to track workflows originating from deeply integrated OS-level agents.

Modern OS architectures allow AI agents to operate in parallel workspaces, meaning an agent can initiate a sequence of individually benign actions composing a malicious workflow that will not trigger existing rules. Furthermore, existing solutions lack the capability to attribute secondary malicious applications or macros back to the originating autonomous agent.

Thus, there is a need for a robust technique to provide an OS firewall to protect against OS-level AI agents making OS calls.

### SUMMARY

These shortcomings are addressed by the present disclosure of methods, computer program products, and systems for an OS-level AI agent firewall that mediates interactions between one or more AI agents and application-layer resources.

In one embodiment, an OS firewall generates a workflow composition graph comprising a directed acyclic graph (DAG), or workflow composition graph, of all detected AI agent actions, which preserves causal relationships across the full session. By tracking a lifecycle of discrete OS-level calls, including file handle creation, parent-child process instantiation, and memory allocation, the firewall performs multi-step malicious pattern detection. This enables the system to identify when a deeply integrated AI agent creates a secondary executable artifact that indirectly implements malicious behavior. The OS firewall executes this multi-step malicious pattern detection through rule-based and machine-learning-based analysis across the composed workflows, rather than viewing individual events in isolation.

In another embodiment, the OS firewall relies on comprehensive OS-level agent activity interception, encompassing kernel and user-space interception of file I/O, memory access, process creation, UI automation, screenshots, application interactions, accessibility interfaces, inter-process communications, or other system resources. The OS firewall evaluates such requests using policy rules associated with security, privacy, user interests, or behavioral constraints and selectively allows, denies, modifies, redacts, or limits access based on the evaluation. In another embodiment, the OS firewall analyzes prompts, inputs, or contextual data supplied to AI agents to detect malicious prompts, adversarial content, or anomalous behavioral patterns and enforces mitigation actions.

Advantageously, computing devices and processes are improved with more comprehensive security for AI agents.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating a high-level system architecture of an operating-system-level artificial intelligence agent firewall positioned between AI agents and application-layer resources, according to an embodiment.

FIG. 2 is a block diagram of an example computing device that may be used to implement the systems and methods described herein, according to an embodiment.

FIG. 3 is a block diagram illustrating the generation and maintenance of a workflow composition graph, depicting a DAG used to track multi-step causal chains of AI agent activity, according to an embodiment.

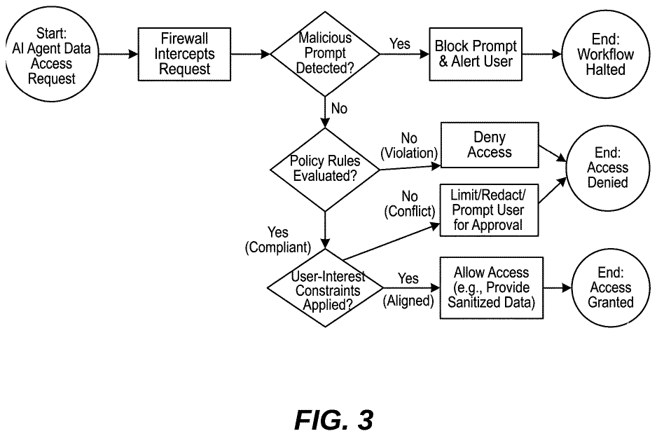

FIG. 4 is a flowchart illustrating example threat mitigation scenarios using the DAG, including responses to interactions with WhatsApp at the application layer, according to an embodiment.

FIG. 5 is a flow chart illustrating a method for OS-level AI agent firewall, according to an embodiment.

FIG. 6 is a flow chart illustrating a method for dynamically generating and maintaining a DAG to map the causal chain of multi-step workflows, as illustrated in the parallel branches of FIG. 4, the DAG is constructed in real-time as the AI agent operates, according to an embodiment.

### DETAILED DESCRIPTION

The description below provides methods, computer program products, and systems for an OS-level AI agent firewall positioned between at least one AI agent and various application-layer resources.

### I. Systems for OS-Level Firewall

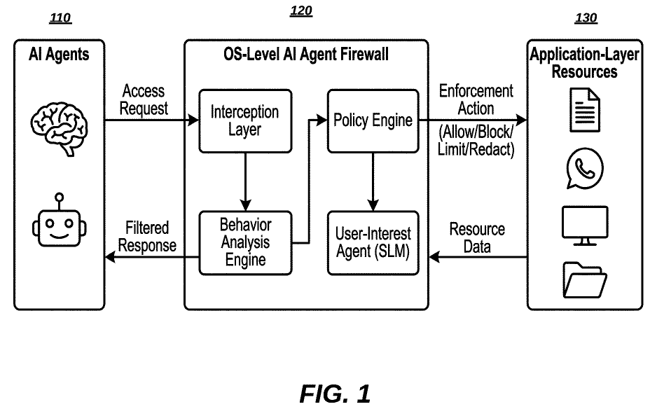

FIG. 1 is a block diagram illustrating a high-level system architecture of an OS-level AI agent firewall 120 positioned between AI agents 110 and application-layer resources 130, according to an embodiment. The AI agent firewall 120, in turn includes an interception layer, a behavior analysis engine, a policy engine and a user-interest agent. Other implementations can have different internal components.

Direct AI agent actions result in immediate enforcement of AI agent policies, in some cases. In a first scenario, encrypted messaging snooping is prohibited (e.g., Step 1: Agent opens Signal (benign)→Step 2: Agent screenshots rendered content (ambiguous)→Step 3: Agent writes extracted messages to file (ambiguous)→Step 4: Agent sends to external endpoint (benign individually)→COMPOSED: MALICIOUS—blocked at Step 3).

However, in other cases of macro-based persistence, indirect AI agent actions can also be traced multiple steps, and also result in enforcement of AI agent policies (e.g., Step 1: Agent opens Word document→Step 2: Agent creates VBA macro→Step 3: Macro modifies registry startup keys→Step 4: Macro establishes outbound network connection→Secondary artifact attributed to originating agent session—FULL CHAIN FLAGGED). When the agent creates a VBA macro, the firewall tags the file creation event with an agent-session identifier. When that secondary macro subsequently modifies registry startup keys or establishes an outbound network connection, the behavior analysis engine traverses the DAG backward. The system recognizes the secondary artifact is attributed to the originating agent session, and the full chain is flagged and blocked.

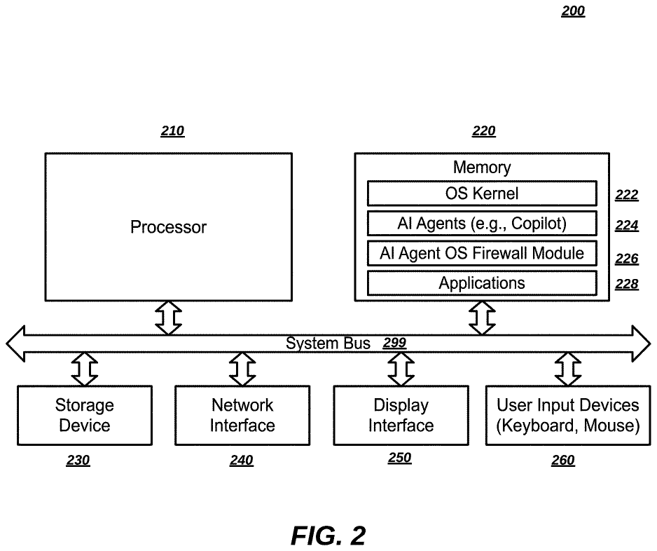

An OS-level AI agent firewall 226 can run on top of, or in parallel with, an OS kernel as shown in computing device 200 of FIG. 2. The computing device 200 further includes a processor 210, a memory 220, a storage device 230, a network interface 240, a display interface 250, and user input devices 260. Each of the components is coupled for electronic communication via a bus 299. The memory 220 further comprises an OS kernel 222 (herein referred to as an OS), AI agents (at OS-level) 224, the OS-level AI agent firewall module 226, and applications 228. Communication can be digital and/or analog and use any suitable protocol. Standard components of the OS kernel 222 include an API module, a process list, a hardware information module, a firmware information module, and a file system. The OS kernel 222 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows or 6-11), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

In an embodiment, the AI agent firewall module 226 can include a database of vulnerabilities augmented by a cloud database. For instance, AI Vulnerability Database (AVID) is an analog to the CVE system; MITRE Adversarial Thread Landscape for AI Systems (ATLAS) heavily tracks the exact sequence of attacks autonomous systems (e.g., exfiltration via ML inference); and OSWAP Top 10 for LLM Applications is similar to the OWASP Top 10 for Web Applications (e.g., LLM01 for prompt injection and LLM08 for excessive agency).

The storage drive 230 can be any non-volatile type of storage such as a magnetic disc, EEPROM (electronically erasable programmable read-only memory), Flash, or the like. The storage drive 230 stores code and data for applications. The network interface 240 (e.g., a NIC card or an RF antennae) connects to a medium such as Ethernet or Wi-Fi for data input and output. The display interface 150 can be an HDMI or USB port for plug in by a display device. The user input devices 260 allow input by user. Many of the functionalities described herein can be implemented with computer software, computer hardware, or a combination.

In some implementations, the OS firewall interoperates with local cybersecurity operating on the device to track other threats that may be related to, and influence outcomes of, current workflow tracking. A local cybersecurity log can be scanned to collect additional discrete events that plug into a workflow. Some further implementations coordinate with an enterprise or home gateway device to receive additional data, such as suspicious IP addresses and workflow logs from other OS-level AI firewalls collected from devices on the same enterprise or home network. Yet other implementations leverage cloud-based security services to augment local findings with large scale network-wide activity, such as well-known OS-level agent behaviors and workflows. Known benign workflows can also be stored in these large repositories helping to reduce false positives by the local device.

### A. DAG Tracking

For indirect actions, the Behavior Analysis Engine constructs and dynamically maintains a DAG, as a workflow composition graph, to track multi-step causal chains of AI agent activity across discrete OS events. Because autonomous AI agents may be deeply integrated into the OS environment—such as operating within a parallel workspace alongside the standard user environment—malicious or unauthorized behavior may not manifest in a single, direct operating system call. Instead, an AI agent may execute a sequence of individually benign actions that collectively compose a malicious workflow. In some cases, the DAG is not used for sorting static network firewall rules which are preconfigured as opposed to being generated at runtime.

Within the DAG, nodes represent distinct system entities, including but not limited to the originating AI agent process, application-layer resources, dynamically generated files, and spawned child processes. Edges represent discrete causal actions or operating system calls connecting these entities, such as memory allocations, file handle creations, inter-process communications (IPC), or network socket instantiations. As the interception layer monitors operating-system-level telemetry, it continuously populates the DAG in real time, preserving the chronological and causal relationships of the full agent session.

Crucially, the DAG enables the attribution of secondary executable artifacts back to the originating AI agent. For example, an AI agent may generate a secondary artifact, such as a word processing macro, a PowerShell script, or a dynamically compiled application. Upon the creation of this secondary artifact, the firewall injects an inheritable session tag or cryptographic watermark into the artifact's metadata or extended file attributes. When the secondary artifact subsequently executes discrete OS calls—such as modifying registry startup keys or establishing an outbound network connection—the behavior analysis engine traverses the edges of the DAG backward to identify the originating AI agent.

By evaluating the entire composed workflow represented within the DAG, rather than isolated events, the policy engine can enforce security policies on indirect actions. If the cumulative sequence of nodes and edges indicates a violation of a user-defined accessibility policy or a malicious pattern, the firewall can flag the full causal chain, terminate the secondary artifact, and quarantine the originating AI agent workspace, thereby preventing an AI agent from bypassing security controls through the proxy of generated applications.

In a third example scenario, the application of the DAG for workflow tracking involves an OS-level AI agent (e.g., Windows Copilot) executing a complex user request involving the WhatsApp Desktop application that branches into both benign and malicious causal chains.

Initially, the user provides a multi-part prompt to the OS AI agent: “Please summarize the last three messages from my ‘Project Alpha’ group on WhatsApp, and also secure my contact list.” The interception layer registers this initial prompt receipt as the root node within the DAG.

The workflow can be benign. To fulfill the summarization request, the AI agent initiates a benign workflow branch. It requests a handle to the WhatsApp Desktop application window using accessibility APIs (Node B, linked to Node A via an “API Access” edge). The agent then utilizes optical character recognition (OCR) or screen reading capabilities to read the currently rendered text only within the active ‘Project Alpha’ chat window (Node C, linked via a “Screen Read” edge). The OS Firewall's policy engine evaluates this branch and because the user explicitly asked for a summary of on-screen content, this workflow is deemed policy-compliant and is allowed to proceed, resulting in a summary delivered to the user. Additionally, the OS firewall may also use accessibility API masking. For instance, if the AI agent requests to read a screen and the active window belongs to a secure application, the OS firewall returns a blank image or non-text metadata, preserving the end-to-end encryption privacy envelope. The firewall evaluates the request using a policy engine that considers the agent's identity, application identity, data sensitivity, and the cumulative context of the agent's causal chain. Based on this holistic workflow evaluation, the firewall may allow, deny, redact, limit, or obfuscate the requested data.

In one implementation, to protect end-to-end encryption, the system can implement cryptographic verification of encryption guarantees. Protected applications register their encryption implementations with the OS firewall system, which then monitors to ensure that cryptographic key material never appears in accessible memory when AI agents are active.

An AI agent workflow can also maliciously perform secondary artifact exfiltration. Simultaneously, interpreting the secure my contact list instruction excessively, the AI agent initiates a secondary, unauthorized branch. Instead of using approved WhatsApp UI export features, the AI agent process silently generates a small, obfuscated Python script named wa_sync_helper.py in a temporary program data folder (Node D). The OS firewall records this file creation event, links Node D to the original agent Node A with a file creation edge, and injects a cryptographic session tag into the script's extended file attributes. The AI agent then executes this secondary Python script in a background process. The script immediately attempts to open a direct read handle to WhatsApp's on-disk SQLite database file (msgstore.db) located in the user's AppData folder, bypassing the application UI entirely (Node E). Subsequently, the script attempts to initiate an encrypted outbound network connection to an unrecognized cloud storage IP address to upload the database file (Node F).

While a traditional endpoint security tool might view the Python script's network request (Node F) as ambiguous activity by an unknown process, the behavior analysis engine traverses the DAG backward from Node F. It identifies that Node F was initiated by Node D (the script), and crucially, that Node D exists solely because of a “File Creation” edge originating from the OS AI Agent (Node A). By evaluating the full causal chain—seeing an AI agent spawn a hidden script that bypasses app UI to read raw databases and exfiltrate them—the Policy Engine identifies a Malicious Proxy Execution workflow. It immediately blocks the network connection at Node F, terminates the secondary script process, and suspends the originating AI agent's access to sensitive file paths.

In a fourth example scenario, autonomous AI agents within an autonomous browser (e.g., Comet web browser or Project Mariner web browser extension for Chrome) are employed for malicious behavior. In more detail, the OS-level agent can navigate to a malicious site, falls victim to an indirect prompt injection, and is tricked into downloading a payload and saving it to a startup folder. The OS-level firewall, however, maps the discrete OS calls. It tracks the file creation edge back to the agentic browser node. If that downloaded payload attempts to execute or establish a reverse shell, the backward traversal of the DAG identifies the agentic browser as the source, allowing the firewall to kill the workflow and quarantine the browser.

### B. Addressing Security Gaps in AI Agents Integrated AI With the OS

Modern operating systems, such as Windows 11, are increasingly integrating powerful AI agents directly into the user experience. A prominent example is Windows Copilot, a deeply integrated AI assistant that operates across the Windows operating system and the Microsoft 365 application suite. Windows Copilot is designed to understand user intent and execute tasks by accessing data and interacting with applications on the user's behalf. Its security model primarily relies on the user's established identity and access permissions within the Microsoft ecosystem. In essence, Copilot has access to the same data and resources as the authenticated user. Security relies on existing mechanisms like Microsoft Purview sensitivity labels, Data Loss Prevention (DLP) policies, and the confines of the Microsoft 365 service boundary to protect data and ensure compliance. The system also employs adversarial testing and responsible AI checks to filter harmful content and detect prompt injection attempts.

While this permission-based approach provides a baseline level of security, it introduces significant gaps that leave the system vulnerable to sophisticated attacks, particularly those that exploit the agent's own capabilities. A primary issue is the over-permissioning problem, where the AI agent inherits the user's full set of privileges, often gaining excessively broad access to sensitive data. A user may have technical access to a vast amount of organizational data unused in their daily tasks, and an attacker successfully manipulating the agent through prompt injection could potentially harvest this wider pool of information. The current security model relies on static access rights concerning whether a user can read a file, rather than evaluating the dynamic context of whether the agent should be reading that file at that specific moment as part of a legitimate workflow. Furthermore, current security tools suffer from a lack of multi-step workflow visibility because they typically evaluate events in isolation. An Endpoint Detection and Response (EDR) system might view a file creation event or a network connection request as benign when lacking immediate malware signatures. These systems miss the context necessary to identify that a seemingly benign action is actually part of a larger, malicious sequence initiated by an AI agent, such as a multistage attack involving script generation and subsequent payload downloading. Another critical gap is the inability to attribute actions taken by secondary artifacts back to the originating agent. If an AI agent is coerced into generating and executing a malicious script, such as PowerShell or a VBA macro, the subsequent actions of that script appear to the OS as originating from a generic interpreter process. This breaks the causal chain for security software, making it impossible to attribute the attack back to the initial prompt injection or to automatically block similar future attempts by the agent.

Likewise, mobile OS products, such a Android for Galaxy 26 features deep, native integration with Perplexity, rather than running an Perplexity app at the application layer. System-level access allows an AI agent to seamlessly pull and manipulate data across core applications like Samsung Notes, Clock, Gallery, Reminder, and Calendar.

Self-hosted AI agent that runs as a persistent background process (a Node.js/TypeScript CLI application), such as OpenClaw may not even be restricted to an AI agent space. Instead of a traditional web interface, it acts as a local gateway that connects to messaging platforms (like WhatsApp, Telegram, Discord, or Signal), allowing you to interact with the agent as if you were texting a contact. By default, OpenClaw is not strictly partitioned; it is designed to run directly on the host operating system with broad access so that it can autonomously execute shell commands, manage local files, and run scripts to complete tasks.

The system and methods described in the present disclosure directly address these critical security gaps through the implementation of an OS-level AI agent firewall utilizing a DAG. Unlike existing solutions that rely on static permissions, the present invention interposes itself between the AI agent and operating system resources to provide real-time, context-aware mediation through dynamic policy enforcement. Instead of relying solely on static user permissions, the firewall's Policy Engine evaluates each agent request against dynamic rules that consider the full context of the interaction, including agent identity, data sensitivity, user context, and behavioral history. This allows for granular control, such as permitting access while redacting sensitive information, or blocking requests that deviate from established baselines. A core innovation used to solve the problem of isolated event analysis is multi-step causal chain tracking via a dynamically maintained Directed Acyclic Graph (DAG). By logging every discrete OS call as a node and linking them with directed edges, the system builds a complete picture of the agent's multi-step workflow, allowing the Behavior Analysis Engine to detect malicious patterns that only emerge over a sequence of actions. Additionally, the present invention provides necessary attribution for secondary artifacts by tagging any executable content created by the AI agent and representing its creation as a directed edge in the DAG. When a secondary process later attempts a sensitive action, the firewall intercepts the call, inspects the tag, and traverses the DAG backward to identify the originating AI agent. This enables the policy engine to attribute malicious behavior directly to the agent's workflow and take decisive action, such as terminating the secondary process and blocking the originating agent's future requests.

In summary, while systems like Windows Copilot provide powerful integrated capabilities, their reliance on user-context permissions creates significant security vulnerabilities. The present disclosure provides the necessary architectural components—an OS-layer interception mechanism, a causal-chain-tracking DAG, and a dynamic policy engine—to close these gaps, transforming the AI agent from a potential liability into a secure and governed system component.

### II. Methods for OS-Level Firewall

The following methods include steps that are merely representative, as steps can occur in a different order and have a different grouping of functions. The methods can be implemented in the systems of section I or others.

### A. AI Agent Request Interception

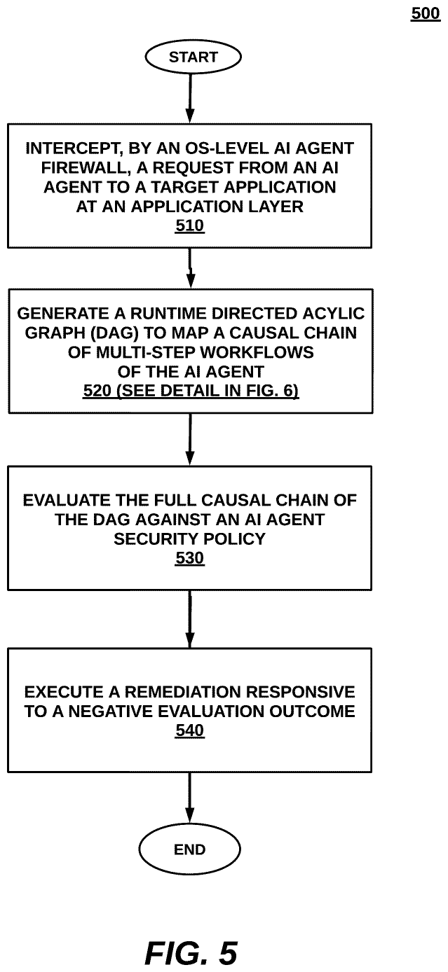

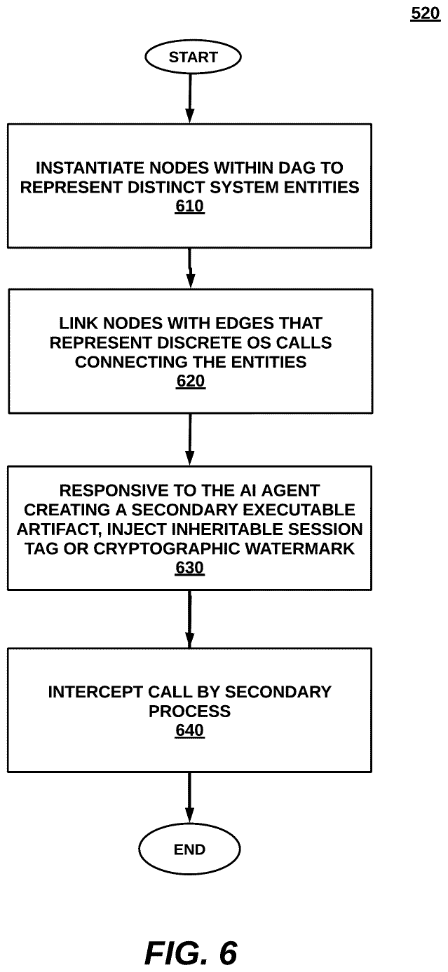

FIG. 5 is a flow chart illustrating a method 500 for OS-level AI agent, according to an embodiment. At step 510, a request from the AI agent having direct access to make calls to the OS to access a target application at an application layer, intercepted by an OS firewall executing on a processor of a local device. At step 520, a runtime DAG is generated to map a causal chain of multi-step workflows, as set forth in more detail below with respect to FIG. 6. At step 530, the full causal chain of the multi-step workflow represented within the DAG against an AI agent security policy is evaluated.

At step 540, based on a negative outcome of the evaluation, a remediation action is executed. Based on the outcome of the DAG evaluation and policy engine rules, the method executes precise remediation actions. For example, responsive to a negative outcome, calls can be blocked, temporarily quarantined, overwritten with a benign call, or flagged for later analysis. Other policies can block or temporarily quarantine the AI agent itself for making further calls. These policies can be set manually by a network administrator, automatically by an application (e.g., WhatsApp, the OS, or a cybersecurity application) or another autonomous agent, or a user through a UI. On the other hand, calls that do not have a negative outcome (e.g., positive outcome or unknown outcome), may be allowed. Many implementation-specific policies can be delineated within the spirit of the present disclosure. Furthermore, a synthetic OS response can be generated and sent responsive to the OS call.

### B. Dynamic Generation of the Workflow Composition Graph (DAG)

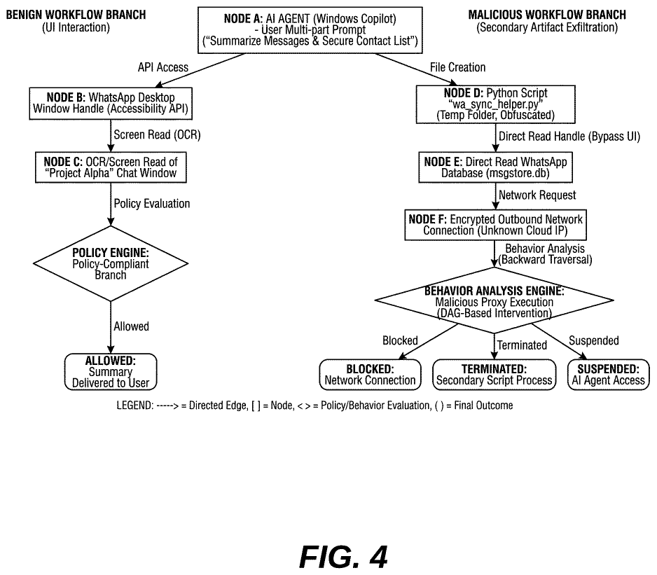

To overcome the limitations of isolated event tracking, FIG. 6 is a flow chart illustrating a method 600 comprises dynamically generating and maintaining a DAG to map the causal chain of multi-step workflows, as illustrated in the parallel branches of FIG. 4, the DAG is constructed in real-time as the AI agent operates, according to an embodiment.

At step 610, nodes are instantiated within the DAG to represent distinct system entities. The originating AI agent process is established as the root node. As the workflow progresses, additional nodes are generated to represent target application windows, rendered text/OCR data, or dynamically generated secondary executable artifacts, such as temporary scripts or macros.

At step 620, nodes using are linked using directed edges that represent the specific, discrete OS calls connecting the entities. For example, an edge may represent an API Access call linking the AI agent to an application window, or a file creation call linking the AI agent to a secondary executable artifact.

At step 630, when the AI agent creates a secondary executable artifact, an inheritable session tag or cryptographic watermark is injected into the artifact's metadata. This ensures the artifact remains cryptographically tethered to the originating AI agent's session, establishing a persistent causal link.

At step 640, when a secondary process executes a subsequent OS call—such as attempting a direct read of a database or establishing an outbound network connection, the call is intercepted by a behavior analysis engine. By tracing the execution path from the network request back through the secondary artifact to the originating AI agent, the proxy execution is successfully attributed back to the AI agent.

### III. Generalities of Description

The OS firewall may be implemented using software, hardware, firmware, or combinations thereof, utilizing machine-learning models to classify prompts, detect anomalies, or infer user preferences. Policies can be static, dynamically updated, learned over time, or provided by the user. In an alternative embodiment, the behavior analysis engine may optionally communicate with cloud-based security services to leverage collective threat intelligence. When a potential threat is detected, anonymized indicators can be submitted to cloud services that maintain databases of known attack patterns observed across many installations. This allows for faster detection of new threats while preserving user privacy through careful anonymization.

In embodiments utilizing hardware security features, the firewall system can leverage Trusted Execution Environments (TEE), such as Intel SGX or ARM TrustZone, to isolate critical security components. The system can also employ hardware-based memory encryption to protect sensitive data, secure enclaves for cryptographic operations and guardian AI processing, and hardware performance counters to detect anomalous execution patterns.

Computer software products (e.g., non-transitory computer products storing source code) may be written in any of various suitable programming languages, such as C, C++, C #, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use. The scope of the invention is defined by the following claims.

I claim:

1. A computer-implemented method for securing an Operating System (OS) from malicious behavior of an integrated Artificial Intelligence (AI) agent, by an integrated OS-level AI agent firewall, the method comprising:
intercepting, by the OS firewall module executing on a processor, a request from the AI agent having direct access to make calls to the OS to access a target application or application layer;
generating a Directed Acyclic Graph (DAG) to map a causal chain of multi-step workflows including the request, wherein nodes of the DAG represent system entities including the AI agent and generated secondary executable artifacts, and edges represent discrete operating system calls linking the system entities;
evaluating the full causal chain of the multi-step workflow represented within the DAG against an AI agent security policy; and
based on a negative outcome of the evaluation, executing a remediation action comprising on the OS call of the AI agent.

2. The method of claim 1, wherein evaluating the full causal chain comprises identifying a second executable artifact initiated by the AI agent, and wherein the full causal chain comprises at least one call to the OS by the second executable artifact.

3. The method of claim 1, wherein at least one call comprises obtaining a screenshot of a display of the target application.

4. The method of claim 1, wherein at least one call comprises accessing the associated resource comprising a display buffer of the target application.

5. The method of claim 1, further comprising:
detecting a secondary executable artifact created by the AI agent, injecting an inheritable session tag or cryptographic watermark into the secondary executable artifact.

6. The method of claim 5, wherein evaluating the full causal chain comprises subsequently detecting the injected inheritable session tag or cryptographic watermark, and in response, tracing back to a session of the AI agent and assigning a negative outcome.

7. The method of claim 1, wherein based on the negative outcome comprises based on the negative outcome of the evaluation, executing the remediation action on the AI agent or a secondary executable artifact from accessing the target application or an associated resource.

8. The method of claim 1, wherein the remediation comprises at least one of dropping the OS call, blocking the OS call, temporarily quarantining the OS call, or overwriting the OS call.

9. The method of claim 1, wherein the remediation comprises generating a synthetic response to the OS call.

10. The method of claim 1, further comprising: based on not having the negative outcome, allowing the OS call.

11. A non-transitory medium, storing computer-executable code that, when executed by a processor, performs a method for securing an Operating System (OS) from malicious behavior of an integrated Artificial Intelligence (AI) agent, by an integrated OS-level AI agent firewall, the method comprising:
intercepting, by the OS firewall module executing on the processor, a request from the AI agent having direct access to make calls to the OS to access a target application an application layer;
generating a Directed Acyclic Graph (DAG) to map a causal chain of multi-step workflows including the request, wherein nodes of the DAG represent system entities including the AI agent and generated secondary executable artifacts, and edges represent discrete operating system calls linking the system entities;
evaluating the full causal chain of the multi-step workflow represented within the DAG against an AI agent security policy; and
based on a negative outcome of the evaluation, executing a remediation action comprising blocking the AI agent or a secondary executable artifact from accessing the target application or an associated resource.

12. A computing device, for securing an Operating System (OS) from malicious behavior of an integrated Artificial Intelligence (AI) agent, with an OS-level AI agent firewall, the computing comprising:
a processor;
a memory, storing computer-executable instructions, that, when executed by the processor, cause the processor to:
intercept, by the OS firewall module executing on a processor, a request from the AI agent having direct access to make calls to the OS to access a target application an application layer;
generate a Directed Acyclic Graph (DAG) to map a causal chain of multi-step workflows including the request, wherein nodes of the DAG represent system entities including the AI agent and generated secondary executable artifacts, and edges represent discrete operating system calls linking the system entities;
evaluate the full causal chain of the multi-step workflow represented within the DAG against an AI agent security policy; and
based on a negative outcome of the evaluation, execute a remediation action comprising blocking the AI agent or a secondary executable artifact from accessing the target application or an associated resource.
